(19) United States
(12) Patent Application Publication
(10) Pub. No.: US 2024/0004464 A1
(43) Pub. Date: Jan. 4, 2024

(54) TRANSMODAL INPUT FUSION FOR MULTI-USER GROUP INTENT PROCESSING IN VIRTUAL ENVIRONMENTS

(71) Applicant: Magic Leap, Inc., Plantation, FL (US)

(72) Inventors: Paul Lacey, Plantation, FL (US); Brian David Schwab, Sunrise, FL (US); Samuel A. Miller, Hollywood, FL (US); John Andrew Sands, Weston, FL (US); Colman Thomas Bryant, Fort Lauderdale, FL (US)

(21) Appl. No.: 18/252,574

(22) PCT Filed: Nov. 9, 2021
(86) PCT No.: PCT/US2021/058641

§ 371 Date: May 11, 2023

Related U.S. Application Data
(60) Provisional application No. 63/113,547, filed on Nov. 13, 2020.

(51) Int. Cl. G06F 3/01

(52) U.S. Cl. CPC G06F 3/013; G06F 3/017; G06F 3/012

(57) ABSTRACT

This document describes imaging and visualization systems in which the intent of a group of users in a shared space is determined and acted upon. In one aspect, a method includes identifying, for a group of users in a shared virtual space, a respective objective for each of two or more of the users in the group of users. For each of the two or more users, a determination is made, based on inputs from multiple sensors having different input modalities, a respective intent of the user. At least a portion of the multiple sensors are sensors of a device of the user that enables the user to participate in the shared virtual space. A determination is made, based on the respective intent, whether the user is performing the respective objective for the user. Output data is generated and provided based on the respective objectives respective intents.

### TECHNICAL FIELD

The present disclosure relates to virtual, augmented, and mixed reality imaging and visualization systems and more particularly to using transmodal input fusion to determine and act on the intent of a group of users in a shared virtual space.

### BACKGROUND

Modern computing and display technologies have facilitated the development of systems for so called “virtual reality”, “augmented reality”, or “mixed reality” experiences, wherein digitally reproduced images or portions thereof are presented to a user in a manner wherein they seem to be, or may be perceived as, real. A virtual reality, or “VR”, scenario typically involves presentation of digital or virtual image information without transparency to other actual real-world visual input; an augmented reality, or “AR”, scenario typically involves presentation of digital or virtual image information as an augmentation to visualization of the actual world around the user; a mixed reality, or “MR,” related to merging real and virtual worlds to produce new environments where physical and virtual objects coexist and interact in real time.

### SUMMARY

This specification generally describes imaging and visualization systems in which the intent of a group of users in a shared space is determined and acted upon. The shared space can include a real space or environment, e.g., using augmented reality, or a virtual space using avatars, game players, or other icons or figures representing real people.

The system can determine the intent of a user based on multiple inputs, including the gaze of the user, the motion of the user's hands, and/or the direction that the user is moving. For example, this combination of inputs can be used to determine that a user is reaching for an object, gesturing towards another user, focusing on a particular user or object, or about to interact with another user or object. The system can then act on the intent of the users, e.g., by displaying the intent of the users to one or more other users, generating group metrics or other aggregate group information based on the intent of multiple users, alerting or providing a recommendation to the user or another user, or reassigning users to different tasks.

In general, one innovative aspect of the subject matter described in this specification can be embodied in methods that include the actions of identifying, for a group of users in a shared virtual space, a respective objective for each of two or more of the users in the group of users. For each of the two or more users, a determination is made, based on inputs from multiple sensors having different input modalities, a respective intent of the user. At least a portion of the multiple sensors are sensors of a device of the user that enables the user to participate in the shared virtual space. A determination is made, based on the respective intent, whether the user is performing the respective objective for the user. Output data is generated for the group of users based on the respective objective for each of the two or more users and the respective intent for each of the two or more users. The output data is provided to a respective device of each of one or more users in the group of users for presentation at the respective device of each of the one or more users.

Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some aspects, the respective objective for at least one user of the two or more users includes at least one of (i) a task to be performed by the at least one user or (ii) an subject object to which the at least one user should be looking. Identifying the respective objective for each of the two or more users includes determining, as the subject object, a target to which at least a threshold amount of the users in the group of users is looking.

In some aspects, the respective device of each user includes a wearable device. Determining the respective intent of the user can include receiving, from the wearable device of the user, gaze data specifying a gaze of the user, gesture data specifying a hand gesture of the user, and direction data specifying a direction in which the user is moving and determining, as the respective intent of the user, an intent of the user with respective to a target object based on the gaze data, the gesture data, and the direction data.

In some aspects, generating the output data based on the respective objective for each of the two or more users and the respective intent for each of the two or more users includes determining that a particular user is not performing the respective objective for the particular user and providing, to the device of each of one or more users in the group of users, the output data for presentation at the device of each of the one or more users comprises providing, to a device of a leader user, data indicating the particular user and data indicating that the particular user is not performing the respective objective for the particular user.

In some aspects, the output data includes a heat map indicating an amount of users in the group of users performing the respective objective of the user. Some aspects can include performing an action based on the output data. The action can include reassigning one or more users to a different objective based on the output data.

The subject matter described in this specification can be implemented in particular embodiments and may result in one or more of the following advantages. Using multimodal input fusion to determine the intent of a group of users in a shared space or one or more users in the group enables a visualization system to provide feedback to the users, determine and improve metrics related to the users, adjust the actions of the users, reassign users to different roles (e.g., as part of real-time rebalancing of loads), and show hidden group dynamics. By determining the intent of the users, the system can predict future actions of the users and adjust actions before they occur. This can increase the efficiency at which tasks are completed and improve safety by preventing users from performing unsafe actions. The use of multiple inputs, such as gaze direction and gesturing enables the visualization system to more accurately determine the intent of users with respect to objects and/or other users relative to other techniques, such as overhead monitoring of the users or avatars representing the users.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is an example of an environment in which a visualization system determines and acts on the intent of a group of users in a shared space.

FIG. 1B is an example of a wearable system.

FIGS. 2A-2C are example attentional models that illustrate the attention of a group of users on a single object.

FIGS. 3A and 3B are example attentional models that illustrate the attention of a group of users on content and a person or interaction with the content.

FIGS. 4A-4C are vector diagrams that depict the attention of a group of users.

FIGS. 5A-5C are heat map diagrams of the user attention corresponding to the vector diagrams of FIGS. 4A-4C, respectively.

FIG. 6 are example attentional models that illustrate the attention of two users with respect to each other and a common object.

FIG. 7 is another example attentional model that illustrates the attention of two users with respect to each other and a common object.

FIG. 8 is an example attentional model that illustrates mutual user to user attention.

FIG. 9 is a flow chart of an example process for determining and acting on the intent of one or more users in a group of users.

FIG. 10 is a block diagram of a computing system that can be used in connection with computer-implemented methods described in this document.

Like reference numbers and designations in the various drawings indicate like elements.

### DETAILED DESCRIPTION

This specification generally describes imaging and visualization systems in which the intent of a group of users in a shared space is determined and acted upon.

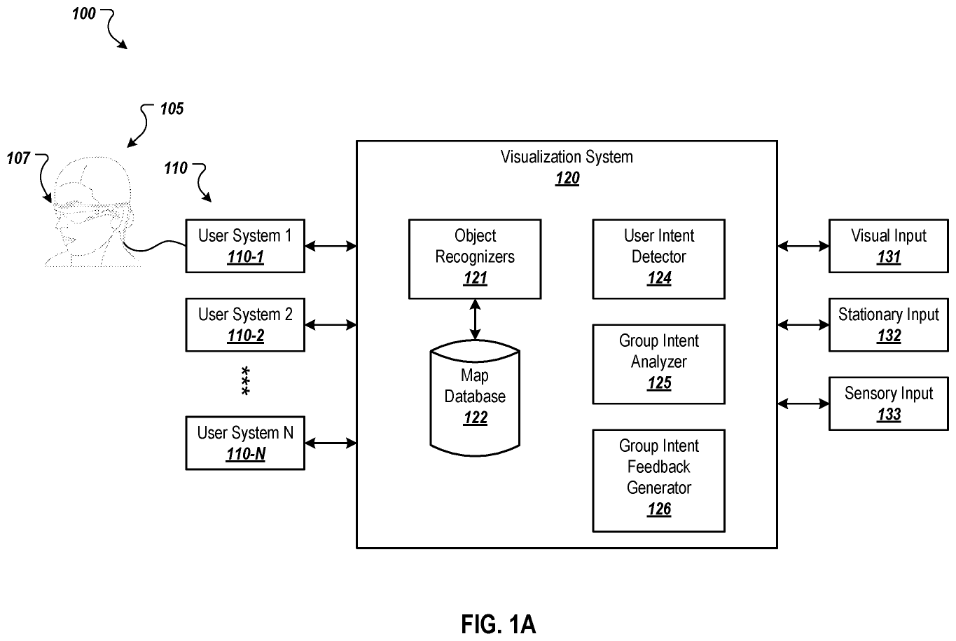

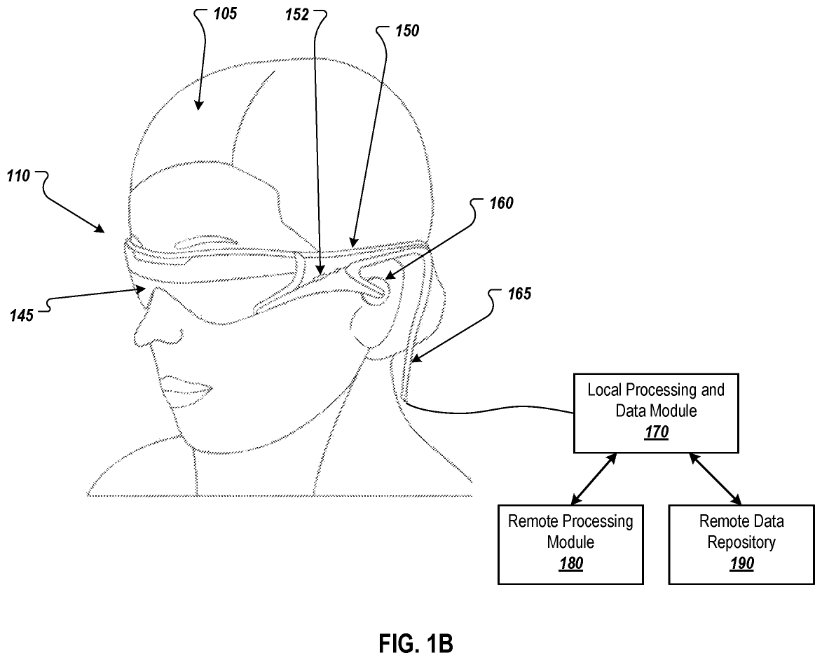

FIG. 1A is an example of an environment 100 in which a visualization system 120 determines and acts on the intent of a group of users in a shared space. The shared space can include a real space or environment, e.g., using augmented reality, or a virtual space using avatars, game players, or other icons or figures representing real people. An augmented reality, virtual reality, or mixed reality space is also referred to as a shared virtual space in this document.

The visualization system 120 can be configured to receive input from user systems 110 and/or other sources. For example, the visualization system 120 can be configured to receive visual input 131 from the user systems 110, stationary input 132 from stationary devices, e.g., images and/or video from room cameras, and/or sensory input 133 from various sensors, e.g., gesture, totems, eye tracking, or user input.

In some implementations, the user systems 110 are wearable systems that include wearable devices, such as the wearable device 107 worn by the user 105. A wearable system (also referred to herein as an augmented reality (AR) system) can be configured to present 2D or 3D virtual images to a user. The images may be still images, frames of a video, or a video, in combination or the like. The wearable system can include a wearable device that can present VR, AR, or MR content in an environment, alone or in combination, for user interaction. The wearable device can be a head-mounted device (HMD) which can includes a head-mounted display.

VR, AR, and MR experiences can be provided by display systems having displays in which images corresponding to a plurality of rendering planes are provided to a viewer. A rendering plane can correspond to a depth plane or multiple depth planes. The images may be different for each rendering plane (e.g., provide slightly different presentations of a scene or object) and may be separately focused by the viewer's eyes, thereby helping to provide the user with depth cues based on the accommodation of the eye required to bring into focus different image features for the scene located on different rendering plane or based on observing different image features on different rendering planes being out of focus.

The wearable systems can use various sensors (e.g., accelerometers, gyroscopes, temperature sensors, movement sensors, depth sensors, GPS sensors, inward-facing imaging system, outward-facing imaging system, etc.) to determine the location and various other attributes of the environment of the user. This information may further be supplemented with information from stationary cameras in the room that may provide images or various cues from a different point of view. The image data acquired by the cameras (such as the room cameras and/or the cameras of the outward-facing imaging system) can be reduced to a set of mapping points.

FIG. 1B shows an example wearable system 110 in more detail. Referring to FIG. 1B, the wearable system 110 includes a display 145, and various mechanical and electronic modules and systems to support the functioning of display 145. The display 145 can be coupled to a frame 150, which is wearable by a user, wearer, or viewer 105. The display 145 can be positioned in front of the eyes of the user 105. The display 145 can present AR/VR/MR content to a user. The display 145 can include a head mounted display (HMD) that is worn on the head of the user. In some embodiments, a speaker 160 is coupled to the frame 150 and positioned adjacent the ear canal of the user (in some embodiments, another speaker, not shown, is positioned adjacent the other ear canal of the user to provide for stereo/shapeable sound control). The display 145 can include an audio sensor 152 (e.g., a microphone) for detecting an audio stream from the environment on which to perform voice recognition.

The wearable system 110 can include an outward-facing imaging system which observes the world in the environment around the user. The wearable system 110 can also include an inward-facing imaging system which can track the eye movements of the user. The inward-facing imaging system may track either one eye's movements or both eyes' movements. The inward-facing imaging system may be attached to the frame 150 and may be in electrical communication with the processing modules 170 or 180, which may process image information acquired by the inward-facing imaging system to determine, e.g., the pupil diameters or orientations of the eyes, eye movements or eye pose of the user 105.

As an example, the wearable system 110 can use the outward-facing imaging system or the inward-facing imaging system to acquire images of a pose of the user (e.g., a gesture). The images may be still images, frames of a video, or a video, in combination or the like. The wearable system 110 can include other sensors such as electromyogram (EMG) sensors that sense signals indicative of the action of muscle groups.

The display 145 can be operatively coupled, such as by a wired lead or wireless connectivity, to a local data processing module 170 which may be mounted in a variety of configurations, such as fixedly attached to the frame 150, fixedly attached to a helmet or hat worn by the user, embedded in headphones, or otherwise removably attached to the user 105 (e.g., in a backpack-style configuration, in a belt-coupling style configuration).

The local processing and data module 170 can include a hardware processor, as well as digital memory, such as non-volatile memory (e.g., flash memory), both of which may be utilized to assist in the processing, caching, and storage of data. The data may include data (a) captured from environmental sensors (which may be, e.g., operatively coupled to the frame 150 or otherwise attached to the user 105), audio sensors 152 (e.g., microphones); or (b) acquired or processed using remote processing module 180 or remote data repository 190, possibly for passage to the display 145 after such processing or retrieval. The local processing and data module 170 may be operatively coupled by communication links, such as via wired or wireless communication links, to the remote processing module 180 or remote data repository 190 such that these remote modules are available as resources to the local processing and data module 170. In addition, remote processing module 270 and remote data repository 190 may be operatively coupled to each other.

In some embodiments, the remote processing module 180 can include one or more processors configured to analyze and process data and/or image information. In some embodiments, the remote data repository 190 can include a digital data storage facility, which may be available through the Internet or other networking configuration in a “cloud” resource configuration.

In some embodiments, the remote processing module 180 can include one or more processors configured to analyze and process data and/or image information. In some implementations, the remote data repository 190 can include a digital data storage facility, which may be available through the Internet or other networking configuration in a “cloud” resource configuration.

Environmental sensors may also include a variety of physiological sensors. These sensors can measure or estimate the user's physiological parameters such as heart rate, respiratory rate, galvanic skin response, blood pressure, encephalographic state, and so on. Environmental sensors can also include emissions devices configured to receive signals such as laser, visible light, invisible wavelengths of light, or sound (e.g., audible sound, ultrasound, or other frequencies). In some embodiments, one or more environmental sensors (e.g., cameras or light sensors) can be configured to measure the ambient light (e.g., luminance) of the environment (e.g., to capture the lighting conditions of the environment). Physical contact sensors, such as strain gauges, curb feelers, or the like, may also be included as environmental sensors.

Referring back to FIG. 1A, the visualization system 120 includes one or more object recognizers 121 that can recognize objects and recognize or map points, tag images, attach semantic information to objects with the help of a map database 122. The map database 122 can include various points collected over time and their corresponding objects. The various devices and the map database 122 can be connected to each other through a network (e.g., LAN, WAN, etc.) to access the cloud. In some implementations, a portion or all of the visualization system 120 is implemented on one of the user systems 110 and the user systems 110 can be in data communication with each other over a network, e.g., a LAN, WAN, or the Internet.

Based on this information and collection of points in the map database 122, the object recognizer 121 can recognize objects in an environment, e.g., a shared virtual space for a group of users. For example, the object recognizer 121 can recognize faces, persons, windows, walls, user input devices, televisions, other objects in the user's environment, etc. One or more object recognizers may be specialized for object with certain characteristics. For example, an object recognizer may be used to recognize faces, while another object recognizer may be used recognize totems, while another object recognizer may be used to recognize hand, finger, arm, or body gestures.

The object recognitions may be performed using a variety of computer vision techniques. For example, the wearable system can analyze the images acquired by an outward-facing imaging system to perform scene reconstruction, event detection, video tracking, object recognition, object pose estimation, learning, indexing, motion estimation, or image restoration, etc. One or more computer vision algorithms may be used to perform these tasks. Non-limiting examples of computer vision algorithms include: Scale-invariant feature transform (SIFT), speeded up robust features (SURF), oriented FAST and rotated BRIEF (ORB), binary robust invariant scalable keypoints (BRISK), fast retina keypoint (FREAK), ViolaJones algorithm, Eigenfaces approach, Lucas-Kanade algorithm, Hom-Schunk algorithm, Mean-shift algorithm, visual simultaneous location and mapping (vSLAM) techniques, a sequential Bayesian estimator (e.g., Kalman filter, extended Kalman filter, etc.), bundle adjustment, Adaptive thresholding (and other thresholding techniques), Iterative Closest Point (ICP), Semi Global Matching (SGM), Semi Global Block Matching (SGBM), Feature Point Histograms, various machine learning algorithms (such as e.g., support vector machine, k-nearest neighbors algorithm, Naïve Bayes, neural network (including convolutional or deep neural networks), or other supervised/unsupervised models, etc.), and so forth.

The object recognitions can additionally or alternatively be performed by a variety of machine learning algorithms. Once trained, the machine learning algorithm can be stored by the HMD. Some examples of machine learning algorithms can include supervised or non-supervised machine learning algorithms, including regression algorithms (such as, for example, Ordinary Least Squares Regression), instance-based algorithms (such as, for example, Leaming Vector Quantization), decision tree algorithms (such as, for example, classification and regression trees), Bayesian algorithms (such as, for example, Naïve Bayes), clustering algorithms (such as, for example, k-means clustering), association rule learning algorithms (such as, for example, a-priori algorithms), artificial neural network algorithms (such as, for example, Perceptron), deep learning algorithms (such as, for example, Deep Boltzmann Machine, or deep neural network), dimensionality reduction algorithms (such as, for example, Principal Component Analysis), ensemble algorithms (such as, for example, Stacked Generalization), and/or other machine learning algorithms. In some embodiments, individual models can be customized for individual data sets. For example, the wearable device can generate or store a base model. The base model may be used as a starting point to generate additional models specific to a data type (e.g., a particular user in the telepresence session), a data set (e.g., a set of additional images obtained of the user in the telepresence session), conditional situations, or other variations. In some embodiments, the wearable HMD can be configured to utilize multiple techniques to generate models for analysis of the aggregated data. Other techniques may include using predefined thresholds or data values.

Based on this information and collection of points in the map database, the object recognizer 121 can recognize objects and supplement objects with semantic information to give life to the objects. For example, if the object recognizer 121 recognizes a set of points to be a door, the visualization system 120 may attach some semantic information (e.g., the door has a hinge and has a 90 degree movement about the hinge). If the object recognizer 121 recognizes a set of points to be a mirror, the visualization system 120 may attach semantic information that the mirror has a reflective surface that can reflect images of objects in the room. Over time the map database 122 grows as the visualization system 120 (which may reside locally or may be accessible through a wireless network) accumulates more data from the world. Once the objects are recognized, the information may be transmitted to one or more wearable systems, e.g., the user systems 110.

For example, an MR environment may include information about a scene happening in California. The environment may be transmitted to one or more users in New York. Based on data received from an FOY camera and other inputs, the object recognizer 121 and other software components can map the points collected from the various images, recognize objects etc., such that the scene may be accurately “passed over” to a second user, who may be in a different part of the world. The environment may also use a topological map for localization purposes.

The visualization system 120 can generate a virtual scene for each of one or more users in a shared virtual space. For example, a wearable system may receive input from the user and other users regarding the environment of the user within the shared virtual space. This may be achieved through various input devices, and knowledge already possessed in the map database. The user's FOY camera, sensors, GPS, eye tracking, etc., convey information to the visualization system 120. The visualization system 120 can determine sparse points based on this information. The sparse points may be used in determining pose data (e.g., head pose, eye pose, body pose, or hand gestures) that can be used in displaying and understanding the orientation and position of various objects in the user's surroundings. The object recognizer 121 can crawl through these collected points and recognize one or more objects using a map database. This information may then be conveyed to the user's individual wearable system and the desired virtual scene may be accordingly displayed to the user. For example, the desired virtual scene (e.g., user in CA) may be displayed at the appropriate orientation, position, etc., in relation to the various objects and other surroundings of the user in New York.

In another example, a shared virtual space can be an instruction room, e.g., a classroom, lecture hall, or conference room. The visualization system 120 can similarly generate a virtual scene for each user in the in the instruction room. In yet another example, the shared virtual space can be a gaming environment in which each user is participating in a game. In this example, the visualization system 120 can generate a virtual scene for each player in the game. In another example, the shared virtual space can be a work environment and the visualization system 120 can generate a virtual scene for each worker in the environment.

The visualization system 120 also includes a user intent detector 124, a group intent analyzer 125, and a group intent feedback generator 126. The user intent detector 124 can determine, or at least predict, the intent of one or more users in a shared virtual space. The user intent detector 124 can determine the intent of a user based on the user inputs, e.g., the visual input, gestures, totems, audio input, etc.

A wearable system can be programmed to receive various modes of inputs. For example, the wearable system can accept two or more of the following types of input modes: voice commands, head poses, body poses (which may be measured, e.g., by an IMU in a belt pack or a sensor external to the HMD), eye gaze also referred to herein as eye pose), hand gestures (or gestures by other body parts), signals from a user input device (e.g., a totem), environmental sensors, etc.

The user intent detector 124 can use one or more of the inputs to determine the intent of a user. For example, the user intent detector 124 can use one or more of the inputs to determine a target object to which the user is directing their focus and/or is going to interact with. In addition, the user intent detector 124 can determine whether the user is viewing the object or in the process of interacting with the object and, if so, the type of interaction that is about to occur.

The user intent detector 124 can use transmodal input fusion techniques to determine the intent of a user. For example, the user intent detector can aggregate direct inputs and indirect user inputs from multiple sensors to produce a multimodal interaction for an application. Examples of direct inputs may include a gesture, head pose, voice input, totem, direction of eye gaze (e.g., eye gaze tracking), other types of direct inputs, etc. Examples of indirect input may include environment information (e.g., environment tracking), what other users are doing, and geolocation.

A wearable system can track, and report to the visualization system 120, the gesture using an outward-facing imaging system. For example, the outward-facing imaging system can acquire images of the user's hands, and map the images to corresponding hand gestures. The visualization system 120 can also use the object recognizer 121 to detect the user's head gesture. In another example, an HMD can recognize head poses using an IMU.

A wearable system can use an inward-facing camera to perform eye gaze tracking. For example, an inward-facing imaging system can include eye cameras configured to obtain images of the user's eye region. The wearable system can also receive inputs from a totem.

The user intent detector 124 can use various inputs and a variety of techniques to determine a target object for a user. The target object can be, for example, an object to which the user is paying attention (e.g., viewing for at least a threshold duration), moving towards, or with which the user is about to interact. The user intent detector 124 can derive a given value from an input source and produce a lattice of possible values for candidate virtual objects that a user may potentially interact. In some embodiments, the value can be a confidence score. A confidence score can include a ranking, a rating, a valuation, quantitative or qualitative values (e.g., a numerical value in a range from 1 to 10, a percentage or percentile, or a qualitative value of “A”, “B”, “C”, and so on), etc.

Each candidate object may be associated with a confidence score, and in some cases, the candidate object with the highest confidence score (e.g., higher than other object's confidence scores or higher than a threshold score) is selected by the user intent detector 124 as the target object. In other cases, objects with confidence scores below a threshold confidence score are eliminated from consideration by the system as the target object, which can improve computational efficiency.

As an example, the user intent detector 124 can use eye tracking and/or head pose to determine that a user is looking at a candidate object. The user intent detector 124 can also use data from a GPS sensor of the user's wearable device to determine whether the user is approaching the candidate object or moving in a different direction. The user intent detector 124 can also use gesture detection to determine whether the user is reaching for the candidate object. Based on this data, the user intent detector 124 can determine the intent of the user, e.g., to interact with the candidate object or to not interact with the object (e.g., just looking at the object).

The group intent analyzer 125 can analyze the intent of multiple users in a group, e.g., a group of users in a shared real or virtual space. For example, the group intent analyzer 125 can analyze the intent of an audience, e.g., a class of students, people viewing a presentation or demonstration, or people playing a game. The group intent analyzer 125 can, for example generate group metrics based on the analysis, reassign tasks of the users based on the analysis, recommend actions for particular users, and or perform other actions, as described below.

For an instruction or presentation, the user group intent analyzer 125 can determine which users are paying attention to the instruction. In this example, the group intent analyzer 125 can either receive data specifying a focus of the instruction, e.g., an instructor user, a whiteboard, a display screen, or a car or other object that is the instruction, or determine the focus of the instruction based on the target object to which the users are looking. For example, if all of the users in the group or at least a threshold number or percentage are looking at the same object, the group intent analyzer 125 can determine that the object is the subject of the instruction.

Throughout the instruction, the user group analyzer 125 can monitor the users to determine which users pay attention to the instruction and compute metrics about the instruction, such as the average group attention, the average amount of time the users spent viewing the instruction, etc. For example, the user group analyzer 125 can determine the percentage of users paying attention to each particular object and the average amount of time each user has paid attention to the object over a given time period. If users are given tasks, the user group analyzer 125 can determine, for each user, whether the user is performing the task, the percentage of time the user has spent performing the task, and aggregate measurements for the group, e.g., the percentage of users performing their tasks, the average amount of time the users in the group have spent performing their tasks, etc.

The user group analyzer 125 can also determine which users are following a display or visual inspection, which users are looking at the leader (e.g., the presenter or a leader in a game), which users are looking at the environment, the group responsiveness to instruction or questions, or potential for task failure (e.g., based on how many users are not following the instruction or paying attention to the leader).

The target object for each user in the group can be used to identify distractions in the shared virtual space. For example, if most users are paying attention to the focus of an instruction, but multiple other users are looking at another object, the group intent analyzer 125 can determine that the other object is a distraction.

The group intent analyzer 125 can compute average group movements and direction of group movement. The user group analyzer 125 can compare this movement data to a target path, e.g., in real time, and give feedback to the instructor using the group intent feedback generator 126 (described below). For example, if the instructor is teaching a fitness or dance class, the user group analyzer 125 can compare the movements of the users to target movements and determine a score of how well the users' movements match the target movements.

In some implementations, each user may be assigned a task, e.g., as part of a group project or team game. The group intent analyzer 125 can monitor the intents of each user and compare the intents to their tasks to determine whether the users are performing their tasks. The group intent analyzer 125 can use this data to compute the task efficiency and/or potential for task failure.

The group intent analyzer 125 can determine hidden group dynamics based on the users' intent. For example, the group intent analyzer 125 can find localized visual attention within a group of users. In a particular example, the group intent analyzer 125 can determine that one subgroup is looking at an instructor while another subgroup is looking at an object being discussed by the instructor.

The group intent analyzer 125 can use this data to determine group imbalance. For example, the group intent analyzer 125 can identify inefficient clustering of users, interference from multiple conflicting leaders, and/or task hand-off slowdowns or errors during production line cooperative tasks.

In some implementations, the group intent analyzer 125 can use multiuser transmodal convergence within the group to determine various characteristics or metrics for the group. The transmodal convergence can include gaze attention (e.g., the level of distraction or engagement of the users), ocular-manual intent (e.g., users' reach, point, grasp, block, push, or throw), ocular-pedal intent to follow a path (e.g., walk, run, jump, side step, lean, or turn), level of physical activity (e.g., ground speed, manual effort, or fatigue), and/or the member and group cognitive (e.g., dissonance, confusion, or elevated cognitive load).

The group intent analyzer 125 can determine group and subgroup statistics and/or metrics. For example, the group intent analyzer 125 can determine group motion (e.g., stop and start count along a path), group physical split and recombination rate, group radius, sub group count (e.g. the number of users performing a particular task or focusing on a particular object), sub group size, main group size, subgroup split and recombination rate, average subgroup membership rate, and/or subgroup characteristics (e.g., gender, age, roles, conversation rate, communication rates, question rate, etc.).

In some implementations, secondary sensors, such as a world camera (if the users provide permission), can face a group of users. In this example, the group intent analyzer 125 can determine additional group characteristics, such as an estimate of the emotional state of the group, a level of tension or relaxation of the group, an estimate of the group discussion intent (e.g., based on the flow of information, contributions from group members, or non-verbal qualification of verbal expression), stylistic group dynamics (e.g., leadership style, presentation style, teaching style, or operating style), and/or body language visual translation (e.g., indication of non-verbally communicated intent from body pose or level of agitation).

The data collected and/or generated by the group intent analyzer 125 can be shared via a local network or stored in the cloud and queried for the above metrics and characteristics, or secondary characteristics. The secondary characteristics can include, for example, identification, localization, or tracking of hidden members of a group that are not wearing a wearable device. The secondary characteristics can also include ghost group members (e.g., the people not wearing a wearable device) in a room and/or ghost group members operating on extended team in extended virtualized spaces. The secondary characteristics can also include the identification, localization, or tracking of people and objects that affect group dynamics that are not part of the group and/or identification of group patterns of motion.

The group intent feedback generator 126 can provide feedback to the users or to a particular user based on the results produced by the group intent analyzer 125. For example, the group intent feedback generator 126 can generate and present, on a display of a particular user, various group metrics. e.g., the number of users paying attention to an instruction, the number of users looking at a leader, etc., for a group of users. This visualization can be in the form of a vector diagram or heatmap that shows the intent or focus of the users. For example, a heatmap can show, for each user, a particular color for the user indicative of the level of attention for that user with respect to a leader or instructor. In another example, the color for a user can represent the efficiency at which the user is performing an assigned task. In this way, the leader viewing the visualization can regain the attention of distracted users and/or get users back on their respective tasks. In another example, as shown in FIGS. 5A-5C, the heatmaps can show areas of attention of the users and the relative number of users paying attention to those areas.

In some implementations, the group intent feedback generator 126 can perform actions based on the results produced by the group intent feedback generator 126. For example, if a subgroup is performing a task inefficiently or is distracted, the group intent feedback generator 126 can reassign users to different tasks or subgroups. In a particular example, the group intent feedback generator 126 can reassign a leader of a well-performing subgroup to an inefficient subgroup to improve the performance of the inefficient subgroup. In another example, if a task is under-resourced, e.g., does not have enough members to perform a task, the group intent feedback generator 126 can reassign users to that subgroup, e.g., from a subgroup that has too many members causing human interference in performing its task.

For individual users, the group intent feedback generator 126 can generate alerts or recommend, to a leader or other user, actions for the individual user. For example, if the user's intent deviates from the task assigned to the user, the group intent feedback generator 126 can generate an alert to notify the leader and/or recommend an action for the individual user, e.g., a new task or a correction to the way the user is performing a current task.

The group intent feedback generator 126 can also build and update profiles or models of users based on their activities within a group. For example, the profile or model can represent the behavior of the user within groups with information, such as the average level of attention, task efficiency, level of distraction, what objects tend to distract the user, etc. This information can be used by the group intent feedback generator 126 during future sessions to predict how the user will react to various tasks or potential distractions, proactively generate alerts to leaders, assign appropriate tasks to the user, and/or determine when to reassign the user to different tasks.

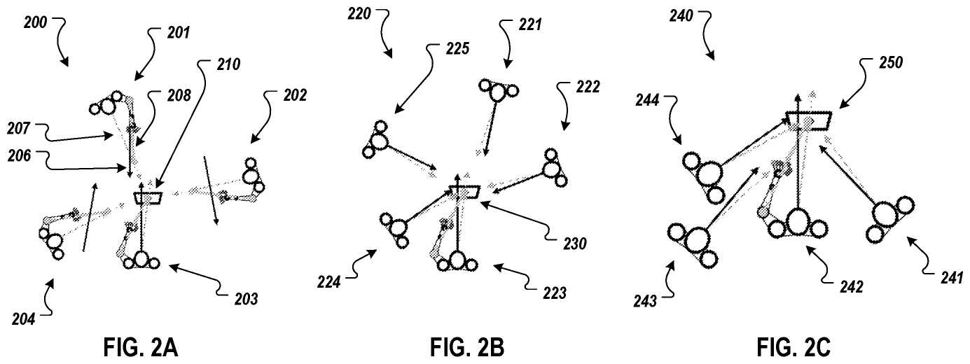

FIGS. 2A-2C are example attentional models 200, 220, and 240, respectively, that illustrate the attention of a group of users on a single object. Referring to FIG. 2A, the model 200 includes a group of users 201-204 who are all looking at the same object 210. As shown for the user 201, in FIG. 2A each user 201-204 has a solid arrow 206 that shows the user's head pose direction, a dashed arrow 207 that shows the user's gaze direction, and a line 208 with circles on either end that shows the direction of gesture of the user's arm. The same types of arrows/lines are used to show the same information for FIGS. 2A-8.

A visualization system can recognize the head pose direction can recognize head poses using an IMU. The visualization system can also recognize the gaze direction of each user using eye tracking. The visualization system can also user gesture detection techniques to determine the direction that the users are moving their arms. Using this information, the visualization system can determine, for the model 200, that all of the users 201-204 are looking at the object 210 and that all of the users 201-204 are reaching for the same object.

The visualization system can use this information to perform actions, generate alerts, or to generate and present data to one or more users. For example, the visualization system can assign a task to the users 201-204. In a particular example, the visualization system may have assigned the users 201-204 the task of picking up the object. Based on the gaze direction and arm direction of each user in combination with their relative locations to the object 210, the visualization system can determine that all of the users 201-024 are reaching for the object 210 but that the user 202 is further from the object than the other users. In response, the visualization system can instruct the other users to wait a particular time period or wait until a countdown provided to each user 201-204 is completed. In this way, the visualization system can synchronize the task of the users based on their collective intents.

Referring to FIG. 2B, the model 220 includes a group of users 221-225 who are all looking at the same object 230. In this example, one user 223 is gesturing towards the object 230. This user 223 may be the leader of the group or a presenter or instructor that is talking about the object 230. In another example, the object 230 can be a table holding another object that the user 223 is describing to the other users. This model can be used to show the user 223 information about the other users' focus. Although in this example all of the other users are looking at the object 230, in other examples some users may be looking at the user 223 or elsewhere. If so, having information about the attention of the users can help the user 223 bring the focus of such users back to the object 230 or to the user 223 if appropriate.

Referring to FIG. 2C, the model 240 includes a group of users 241-244 who are all looking at the same object 250. In this example, one user 242 is gesturing towards the object 250. For example, the user 242 can be a leader or instructor for the group and the object 250 can be a whiteboard or display that the other users are supposed to be watching. Similar to the model 220, the information about what the other users are looking at can help the user 242 get the other users to focus properly.

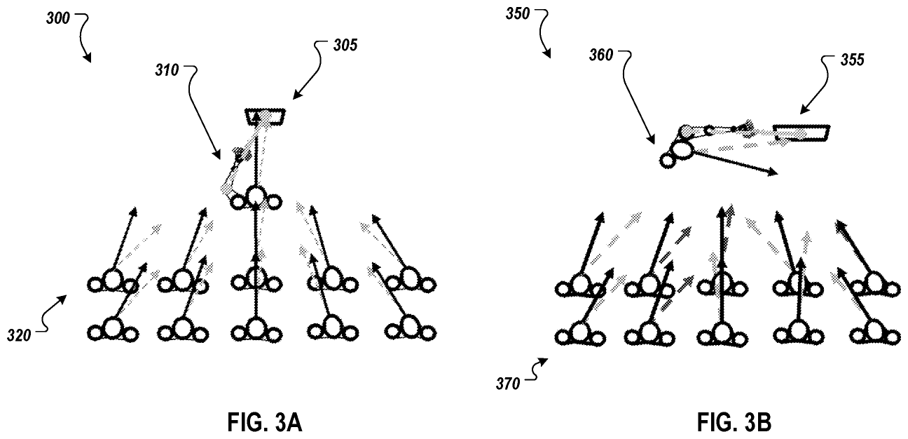

FIGS. 3A and 3B are example attentional models 300 and 350 that illustrate the attention of a group of users on content and a person or interaction with the content. Referring to FIG. 3A, a leader user 310 is talking to a group of users 320 with reference to an object 305, e.g., a whiteboard, display, or other object. In this example, the group is exhibiting singular attention on the object 305 as shown by the dashed arrows that represent the users' gaze.

In contrast, in FIG. 3B, the model 350 represents split or divergent audience attention. In this example, a leader user 360 is standing beside the object 355 that is the subject of the discussion. Some users of a group of users 370 are looking at the leader user 360, while other users are looking at the object 355. If the users should be paying attention to the leader user 360 or the object 355, the visualization system can alert the users paying attention to the wrong object or alert the leader user 360 so that the leader user 360 can correct the other users.

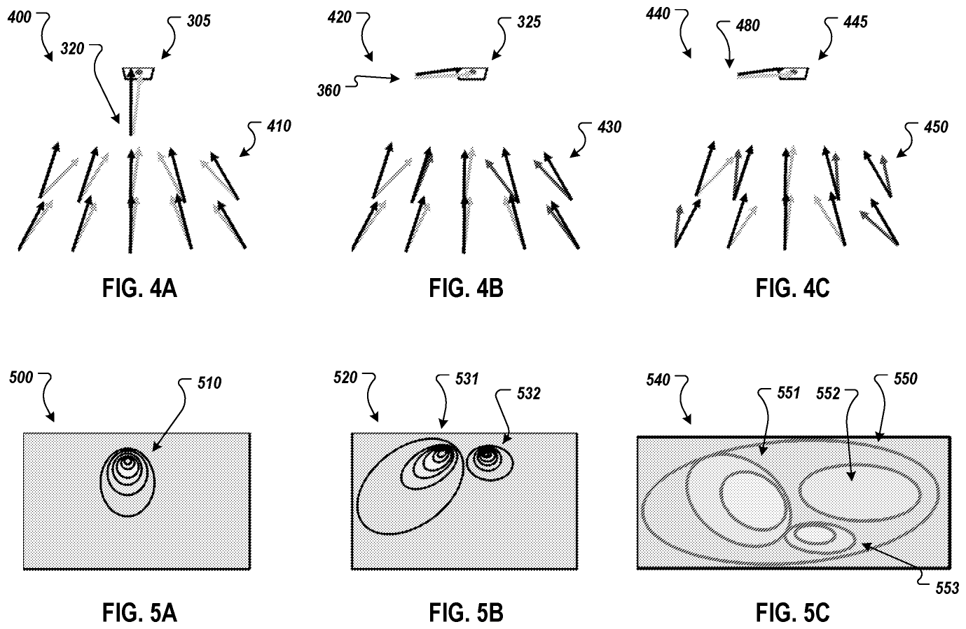

FIGS. 4A-4C are vector diagrams 400, 420, and 440, respectively, that depict the attention of a group of users. FIGS. 5A-5C are heat map diagrams 500, 520, and 540 of the user attention corresponding to the vector diagrams of FIGS. 4A-4C, respectively. The vector diagram 400 and the heat map diagram 500 are based on the attention of the group of users in the model 300 of FIG. 3A. Similarly, the vector diagram 420 and the heat map diagram 520 are based on the attention of the group of users in the model 320 of FIG. 3B. The vector diagram 440 and the heat map diagram 540 are based on the attention of a divergent audience that includes users that are focusing on many different areas rather than concentration on one or two particular objects.

The heat map diagrams 500, 520, and 540 are shown in two dimensions but represent three dimensional heat maps. The heat map diagrams include ellipsoids that are shown as ellipses and that represent areas of attention of users in a group of users. A smaller ellipse that is presented over a larger ellipse represents a higher or taller ellipsoid if the third dimension was shown. The height of an ellipsoid can represent the level of attention that the users in the group have paid to the area represented by the ellipsoid, e.g., taller el have more attention or lower attention. The area of the ellipsoids show in FIGS. 5A-5B represent an area of attention of the users, e.g., wider areas represent larger areas where the users focused their attention. As the ellipses represent ellipsoids, the following discussion refers the ellipses as ellipsoids.

Referring to FIGS. 4A and 5A, a vector diagram 400 and heat map diagram 420 represent the attention of the group of users 320 of FIG. 3A. The vector diagram 400 includes a set of vectors 410 that represent the attention of users in the group. In this example, the vector diagram 400 represents a singular attention of a group of users on the same object 305. As described above with reference to FIG. 3A, each user in the group is looking at the same object.

The heat map diagram 500 of FIG. 5A includes multiple ellipsoids that each represent an area in front of the users. For example, the object 305 may be on a stage or table in front of the users. The heat map diagram 500 can represent that area and include an ellipsoid for each portion of the area that at least one user viewed over a period of time. The area covered by each ellipsoid can correspond to an area in front of the users.

The heat map diagram 500 can represent a rolling average attention of the users over a given time period, e.g., the previous 5 minutes, 10 minutes, 30 minutes, or another appropriate time period. In this way, the ellipsoids of the heat map diagram 500 can move and change size as the attention of the users change.

In this example, a user, e.g., the user 320, can view the heat map diagram 500 and determine that the users are all focused towards the user 320 or the object 305. Thus, the user may not have to perform any action to bring the focus of the users back to the user 320 or the object 305.

Referring to FIGS. 4B and 5B, a vector diagram 420 and heat map diagram 520 represents split attention between the group of users 370 of FIG. 3B. The vector diagram 420 includes a set of vectors 430 that represent the attention of users in the group. Some of the users 430 are looking at an object 325 while other users are looking at the user 360, e.g., discussing the object 325. The heat map diagram includes a first set of ellipsoids 531 that represents the area where the user 360 is located and a second set of ellipsoids 532 that represents the area where the object 325 is located. The smaller area ellipsoid at the top of the ellipsoids 531 can represent the location where the user 360 spent the most time as it is higher than the other ellipsoids, representing more attention to the location represented by the ellipsoid. The ellipsoids having the larger areas can represent larger areas where the user 306 may have moved or where users in the group may have looked at although the user 360 was not there as the aggregate level of attention for those ellipsoids are lower. As the object 325 may not have moved at all, the area of the largest ellipsoids 532 are smaller than those in the set of ellipsoids 531.

Referring to FIGS. 4C and 5C, a vector diagram 420 and heat map diagram 520 represents divergent attention between a group of user. The vector diagram 420 includes a set of vectors 430 that represent the attention of users in the group. In this example, some of the users are looking at an object 445 while other users are looking at a leader user 480 discussing the object 445.

The heat map diagram 550 includes an ellipsoid 550 having a large area representing all of the areas that the users have focused their attention over a given time period. In addition, the heat map diagram 540 includes ellipsoids 551-553 that represent smaller areas where users focused more attention, e.g., more users focused their attentions in those areas or the users focused their attention to those areas for longer periods of time. A user viewing this heat map diagram can learn that the users are not focusing well on either the user 480 or the object 445 and may interrupt the presentation or instruction to regain the users' attention. In another example, the visualization system can determine, based on the aggregate attention and the disparities between the ellipsoids, that the users are not focused on the same object and generate an alert to the user 480 or to the group of users.

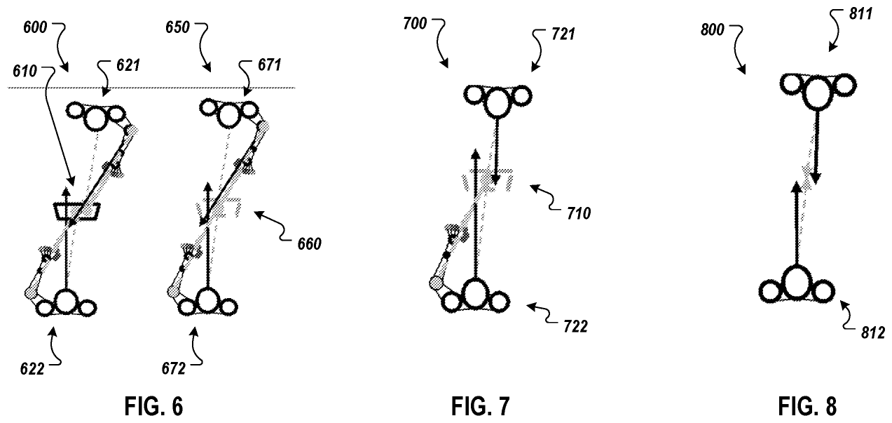

FIG. 6 are example attentional models 600 and 650 in which the attention of two users is on a common object. The model 600 represents two users 621 and 622 looking at and gesturing towards an object 610. The model 650 represents two users 671 and 672 looking at and gesturing towards each other rather than the object 610.

FIG. 7 is another example attentional model 700 in which the attention of two users 721 and 722 is on a common object 710. In this example, the attention of the user 722 is to one side of the object 710 and the level of confidence that the user 722 is looking at the object 710 may be lower than that of the user 721 using gaze or eye tracking alone. However, the user 722 if gesturing towards the object 710, which may increase the confidence.

FIG. 8 is an example attentional model 800 in which there is mutual user to user attention. In particular, a user 811 is looking at another user 822 and the user 822 is looking at the user 811.

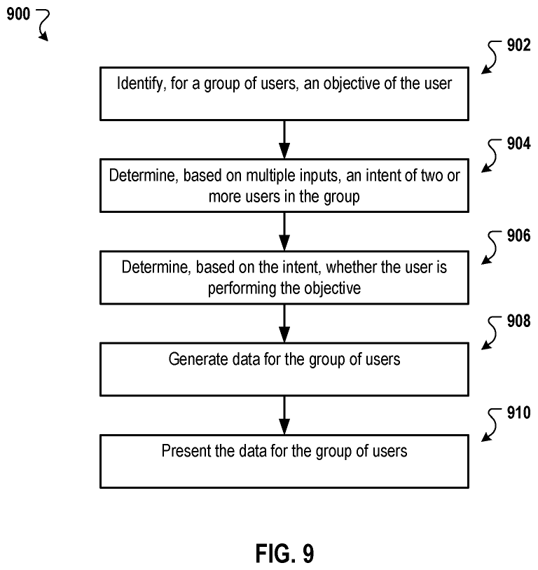

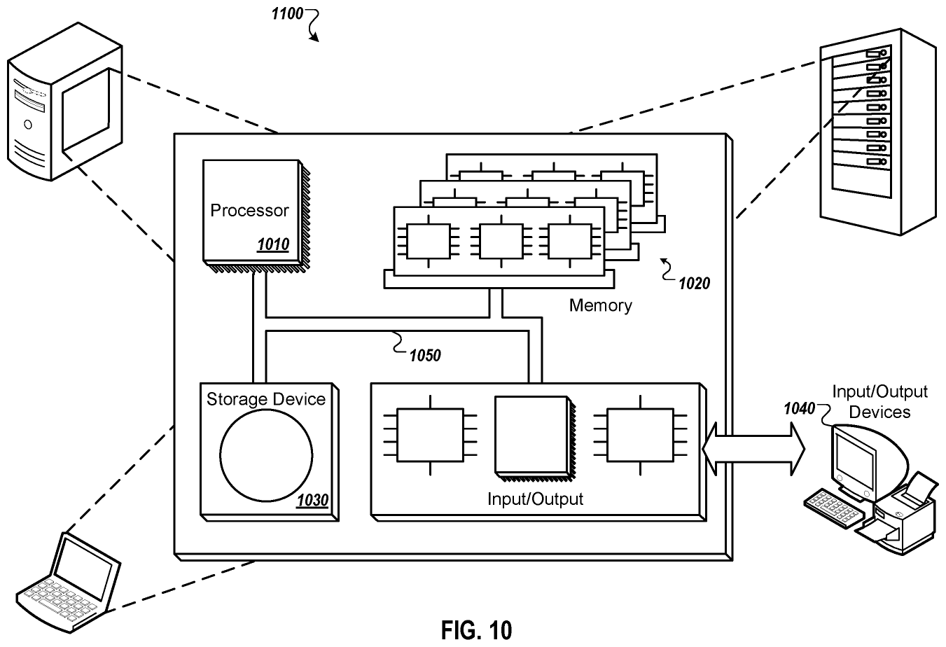

FIG. 9 is a flow chart of an example process 900 for determining and acting on the intent of one or more users in a group of users. The process can be performed, for example by the visualization system 120 of FIG. 1A.

The system identifies, for a group of users in a shared virtual space, a respective objective for each of two or more of the users in the group of users (902). The shared virtual space can include a real space or environment, e.g., using augmented reality, or a virtual space using avatars, game players, or other icons or figures representing real people.

The objective for a user can be a task to be performed by the user. For example, a leader can assign tasks to individual users in a group or to subgroups of users. In another example, the system can assign tasks to user randomly, pseudo-randomly, or based on profiles for the users (e.g., based on previous performance, such as task efficiency or level of distraction, in performing previous tasks).

The objective of a user can be to pay attention to a subject object, e.g., a physical object or a virtual object. The subject object can be a person, e.g., an instructor or presenter, a display or whiteboard, a person on which surgery is being performed, an object being demonstrated or repaired, or another type of object. In this example, the subject object can be specified by a leader or by the system. For example, the system can determine the subject object based on an amount of the users, e.g., at least a threshold percentage such as 50%, 75%, etc., that are looking at the subject object.

The system determines, based on multiple inputs, a respective intent for each of two or more users in the group (904). The multiple inputs can be from multiple sensors having different input modalities. For example, the sensors can include one or more imaging systems, e.g., an outward facing imaging system and an inward facing imaging system, environmental sensors, and/or other appropriate sensors. At least some of the sensors can be part of a device of the user, e.g., a wearable system as described above, that enables the user to participate in a shared virtual space. Other sensors can include a map of the virtual space and/or object recognizers, to name a couple of examples.

The intent can define a target object with which a user is likely to interact and the user interaction with the target object. For example, if a user is walking towards a target object and looking at the object, the system can determine that the user is likely to interact with the target object.

The multiple inputs can include gaze data specifying a gaze of the user, gesture data specifying a hand gesture of the user, and direction data specifying a direction in which the user is moving. For example this data can be received from a wearable device of the user, as described above. Using such data enables the system to more accurately determine the intent of the user.

For each of the two or more users, the system determines whether the user is performing the user's objective (906). The system can make this determination based on a comparison between the determined intent for the user and the user's objective. For example, if the determined intent (e.g., pick up a particular object) matches the user's objective (also pick up the target object), the system can determine that the user is performing, e.g., carrying out or achieving, the user's objective. If the user is moving away from the target object, e.g., with an intent to interact with a different object, the system can determine that the user is not performing the user's objective.

In another example, the objective of the users may be to watch a demonstration or instructor. The system can determine a target object at which each user is looking and determine how many users are actually watching the demonstration, how many users are watching the instructor or presenter, and/or how many users are watching an object that is the subject of the instruction or presentation. In this example, the objective for the users may be to pay more attention to the subject object rather than the instructor or presenter. The system can determine the level of attention of the group of users with respect to the subject object and/or the instructor or presenter, e.g., based on the number of users looking at each and/or the percentage of time each user is looking at each. The system can then determine whether the users, individually or as a group, are performing this objective based on the level of attention for the user or group of users.

The system generates output data for the group of users (908). The output data can include characteristics, statistics, metrics, and/or the status of individual users or the group of users. For example, is a particular user is not performing the user's objective, the output data can indicate who the particular user is, that the user is not performing the objective, and the objective. The output data can indicate how many users are performing their objective, e.g., the number or percentage of users, which users are performing their objectives (e.g., who is looking at a presenter or subject object), average group movement, potential for task failure, etc.

In some implementations, the output data can include a graph or chart. For example, the system can generate a heatmap that indicates, for the group, the amount of users performing their objectives. For example, the heatmap can include a range of colors or shades that indicate the level at which a user is performing an objective. The heatmap can include, for each user, an element representative of the user and that element can be presented in the color matching the level at which the user is performing the user's objective.

The system provides the output data for presentation at a device for each of one or more users (910). For example, the system can provide the output data to a leader of the group. In this example, the user can take action based on the data, e.g., to correct the intent of one or more users.

In some implementations, the system can take action based on the output data. For example, the system can perform corrective or improvement actions such as reassigning tasks from users that are not performing their objectives to other users that have already performed their objectives. In another example, the system can determine that some group tasks are under-resourced and reassign other users to that subgroup.

In a presentation or instruction environment, the system may determine that at least a threshold amount (e.g., number or percentage) of users are distracted or otherwise not paying attention to the subject object. In this example, the system can perform an action to get the users to pay attention, e.g., by presenting a notification on their displays to pay attention to the subject object.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

An example of one such type of computer is shown in FIG. 10, which shows a schematic diagram of a generic computer system 1000. The system 1000 can be used for the operations described in association with any of the computer-implemented methods described previously, according to one implementation. The system 1000 includes a processor 1010, a memory 1020, a storage device 1030, and an input/output device 1040. Each of the components 1010, 1020, 1030, and 1040 are interconnected using a system bus 1050. The processor 1010 is capable of processing instructions for execution within the system 1000. In one implementation, the processor 1010 is a single-threaded processor. In another implementation, the processor 1010 is a multi-threaded processor. The processor 1010 is capable of processing instructions stored in the memory 1020 or on the storage device 1030 to display graphical information for a user interface on the input/output device 1040.

The memory 1020 stores information within the system 1000. In one implementation, the memory 1020 is a computer-readable medium. In one implementation, the memory 1020 is a volatile memory unit. In another implementation, the memory 1020 is a non-volatile memory unit.

The storage device 1030 is capable of providing mass storage for the system 1000. In one implementation, the storage device 1030 is a computer-readable medium. In various different implementations, the storage device 1030 may be a floppy disk device, a hard disk device, an optical disk device, or a tape device.

The input/output device 1040 provides input/output operations for the system 1000. In one implementation, the input/output device 1040 includes a keyboard and/or pointing device. In another implementation, the input/output device 1040 includes a display unit for displaying graphical user interfaces.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more data processing apparatus, the method comprising:
identifying a respective objective for each of two or more users in a group of users;
for each of two or more users:
determining, based on inputs from multiple sensors having different input modalities, a respective intent of the user, wherein at least a portion of the multiple sensors are sensors of a device of the user that enables the user to participate in a shared virtual space; and
determining, based on the respective intent of the user, whether the user is performing a respective objective for the user;
generating, for the group of users, output data based on a respective objective for each of the two or more users and a respective intent for each of the two or more users; and
providing, to a respective device of each of one or more users in the group of users, the output data for presentation at the respective device of each of the one or more users.

2. The method of claim 1, wherein a respective objective for at least one user of two or more users comprises at least one of (i) a task to be performed by at least one user or (ii) a subject object to which at least one user should be looking.

3. The method of claim 2, wherein identifying a respective objective for each of two or more users, comprises determining, as the subject object, a target to which at least a threshold amount of users in the group of users is looking.

4. The method of claim 1, wherein:
a respective device of each user comprises a wearable device; and
determining a respective intent of a user comprises:
receiving, from the wearable device of the user, gaze data specifying a gaze of the user, gesture data specifying a hand gesture of the user, and direction data specifying a direction in which the user is moving; and
determining, as the respective intent of the user, an intent of the user with respective to a target object based on the gaze data, the gesture data, and the direction data.

5. The method of claim 1, wherein:
generating, for the group of users, output data based on a respective objective for each of two or more users and a respective intent for each of two or more users, comprises determining that a particular user is not performing the respective objective for the particular user; and
providing, to a respective device of each of one or more users in the group of users, the output data for presentation at the respective device of each of one or more users, comprises providing, to a device of a leader user, data indicating the particular user and data indicating that the particular user is not performing the respective objective for the particular user.

6. The method of claim 1, wherein the output data comprises a heat map indicating an amount of users in the group of users performing a respective objective of a user.

7. The method of claim 1, further comprising performing an action based on the output data.

8. The method of claim 7, wherein the action comprises reassigning one or more users to a different objective based on the output data.

9. A computer-implemented system, comprising:
one or more computers; and
one or more computer memory devices interoperably coupled with the one or more computers and having tangible, non-transitory, machine-readable media storing one or more instructions that, when executed by the one or more computers, perform operations comprising:
identifying, for a group of users in a shared virtual space, a respective objective for each of two or more users in the group of users;
for each of two or more users:
determining, based on inputs from multiple sensors having different input modalities, a respective intent of the user, wherein at least a portion of the multiple sensors are sensors of a device of the user that enables the user to participate in the shared virtual space; and
determining, based on the respective intent of the user, whether the user is performing a respective objective for the user;
generating, for the group of users, output data based on a respective objective for each of the two or more users and a respective intent for each of the two or more users; and
providing, to a respective device of each of one or more users in the group of users, the output data for presentation at the respective device of each of the one or more users.

10. The computer-implemented system of claim 9, wherein a respective objective for at least one user of two or more users, comprises at least one of (i) a task to be performed by at least one user or (ii) a subject object to which at least one user should be looking.

11. The computer-implemented system of claim 10, wherein identifying a respective objective for each of the two or more users comprises determining, as the subject object, a target to which at least a threshold amount of users in the group of users is looking.

12. The computer-implemented system of claim 9, wherein:
a respective device of each user comprises a wearable device; and
determining a respective intent of a user comprises:
receiving, from the wearable device of the user, gaze data specifying a gaze of the user, gesture data specifying a hand gesture of the user, and direction data specifying a direction in which the user is moving; and
determining, as the respective intent of the user, an intent of the user with respective to a target object based on the gaze data, the gesture data, and the direction data.

13. The computer-implemented system of claim 9, wherein:
generating the output data based on the respective objective for each of the two or more users and the respective intent for each of the two or more users comprises determining that a particular user is not performing the respective objective for the particular user; and
providing, to a respective device of each of one or more users in the group of users, the output data for presentation at the respective device of each of the one or more users comprises providing, to a device of a leader user, data indicating the particular user and data indicating that the particular user is not performing the respective objective for the particular user.

14. The computer-implemented system of claim 9, wherein the output data comprises a heat map indicating an amount of users in the group of users performing the respective objective of a user.

15. The computer-implemented system of claim 9, wherein the operations comprise performing an action based on the output data.

16. The computer-implemented system of claim 15, wherein the action comprises reassigning one or more users to a different objective based on the output data.

17. A non-transitory, computer-readable medium storing one or more instructions executable by a computer system to perform operations comprising:
identifying, for a group of users in a shared virtual space, a respective objective for each of two or more users in the group of users;
for each of two or more users:
determining, based on inputs from multiple sensors having different input modalities, a respective intent of the user, wherein at least a portion of the multiple sensors are sensors of a device of the user that enables the user to participate in the shared virtual space; and
determining, based on the respective intent of the user, whether the user is performing a respective objective for the user;
generating, for the group of users, output data based on a respective objective for each of the two or more users and a respective intent for each of the two or more users; and
providing, to a respective device of each of one or more users in the group of users, the output data for presentation at the respective device of each of the one or more users.

18. The non-transitory, computer-readable medium of claim 17, wherein a respective objective for at least one user of two or more users, comprises at least one of (i) a task to be performed by at least one user or (ii) a subject object to which at least one user should be looking.

19. The non-transitory, computer-readable medium of claim 18, wherein identifying a respective objective for each of the two or more users comprises determining, as the subject object, a target to which at least a threshold amount of users in the group of users is looking.

20. The non-transitory, computer-readable medium of claim 17, wherein:
a respective device of each user comprises a wearable device; and
determining a respective intent of a user comprises:
receiving, from the wearable device of the user, gaze data specifying a gaze of the user, gesture data specifying a hand gesture of the user, and direction data specifying a direction in which the user is moving; and
determining, as the respective intent of the user, an intent of the user with respective to a target object based on the gaze data, the gesture data, and the direction data.
